(19) United States
(12) Patent Application Publication
(10) Pub. No.: US 2010/0125830 A1
(43) Pub. Date: May 20, 2010

(54) Method of Assuring Execution for Safety Computer Code

(75) Inventor: Michael A. Lamana, Manassas, VA (US)

Correspondence Address: Howard IP Law Group, P.O. Box 226, Fort Washington, PA, 19034, US

(73) Assignee: Lockheed Martin Corporation, Bethesda, MD (US)

(21) Appl. No.: 12/274,890

(22) Filed: Nov. 20, 2008

(51) Int. Cl. G06F 9/44

(52) U.S. Cl. 717/121

(57) ABSTRACT

A method and apparatus for preventing inadvertent execution of a segment of computer code is contemplated. One or more allowed executors are associated with each code segment. Each code segment is adapted to autonomously compare an originating code segment to each of the allowed executors to determine if it has been appropriately invoked. When a match is found execution will be allowed to continue, however, when a match is not found the code segment will take appropriate action such as blocking continued execution. In this way inadvertent execution of the code segment is prevented.

### FIELD OF INVENTION

The present invention relates generally to safety computer code, and more particularly to preventing inadvertent execution of a segment of computer code in a computer application.

### BACKGROUND

Prevention of inadvertent execution of a segment of computer code poses a significant challenge to software application developers. By way of example only, inadvertent execution of a segment of code can result from malicious attempts to execute a code segment by an unauthorized external entity or by non-malicious means such as unexpected invocation of the code by automated processes, by code-chaining or by mere misuse. The result may cause unexpected behaviors which are not desirable, particularly in safety related applications. Methods for preventing inadvertent execution of a segment of computer code are desired.

### SUMMARY OF THE INVENTION

A method of preventing inadvertent execution of one or more code segments of a computer program in a processor is contemplated. The method comprises the steps of providing a memory having a first code segment and a second code segment, the first code segment having a first code segment identifier. The process further includes associating one or more allowed code segment identifiers with the second code segment and executing on the processor the first code segment, the first code segment including an instruction for invoking execution of the second code segment. The process further comprises executing on the processor the second code segment wherein the second code segment determines whether the first code segment identifier is the same as one of the one or more allowed code segment identifiers and allowing execution of the second code segment to continue when the first code segment identifier is determined to be the same as one of the one or more allowed code segment identifiers.

In one embodiment, one or more allowed executors are associated with each computer code segment. Each code segment is adapted to autonomously compare an originating code segment to each of the allowed executors to determine if it has been appropriately invoked. When a match is found execution will be allowed to continue, however when a match is not found the code segment will take appropriate action such as blocking continued execution. In this way inadvertent execution of the code segment is prevented.

### BRIEF DESCRIPTION OF THE DRAWINGS

FIG. 1 is a flow diagram illustrating a process in accordance with an exemplary aspect of the invention.

FIG. 2 is a flow diagram illustrating a process in accordance with another exemplary aspect of the invention.

### DETAILED DESCRIPTION

Reference will now be made in detail to the present exemplary embodiments of the invention, examples of which are illustrated in the accompanying drawings.

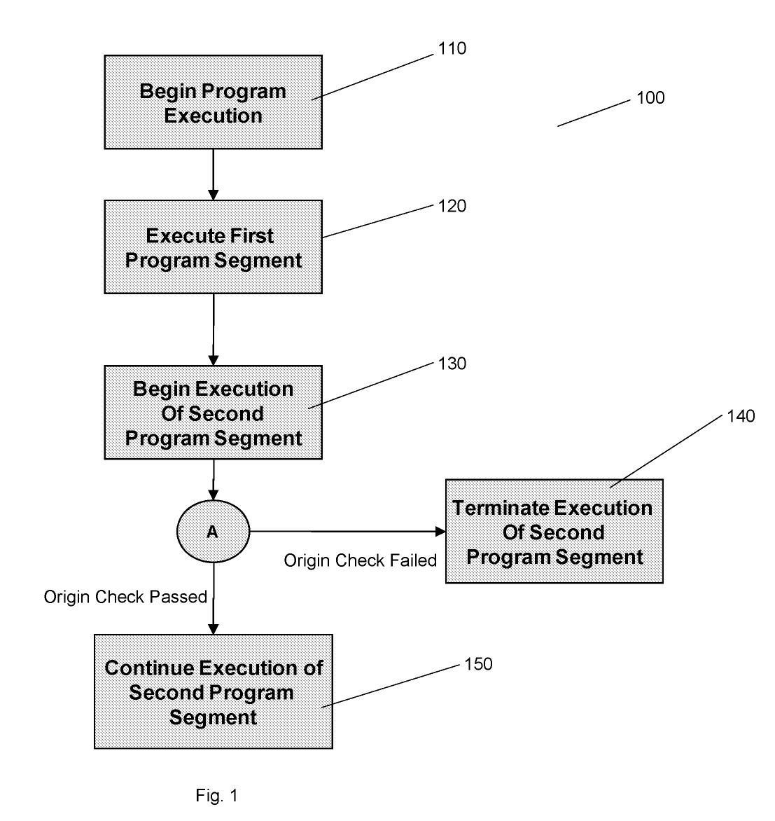

Referring to FIG. 1, a block diagram of a process 100 is shown in accordance with an exemplary embodiment of the invention. The process 100 is an exemplary process that is initiated as part of a computer program that requires secure execution. Process 100 may be carried out on a general computing device, a personal computer, server, or an application-specific computing device having safety related functions.

Process 100 begins with initiation of a program at block 110. The program may be a software application such as a safety critical software application that requires prevention of both malicious and non-malicious inadvertent execution one or more segments of code or any other software application where it is desired to improve reliability by avoiding inadvertent execution of a segment of code.

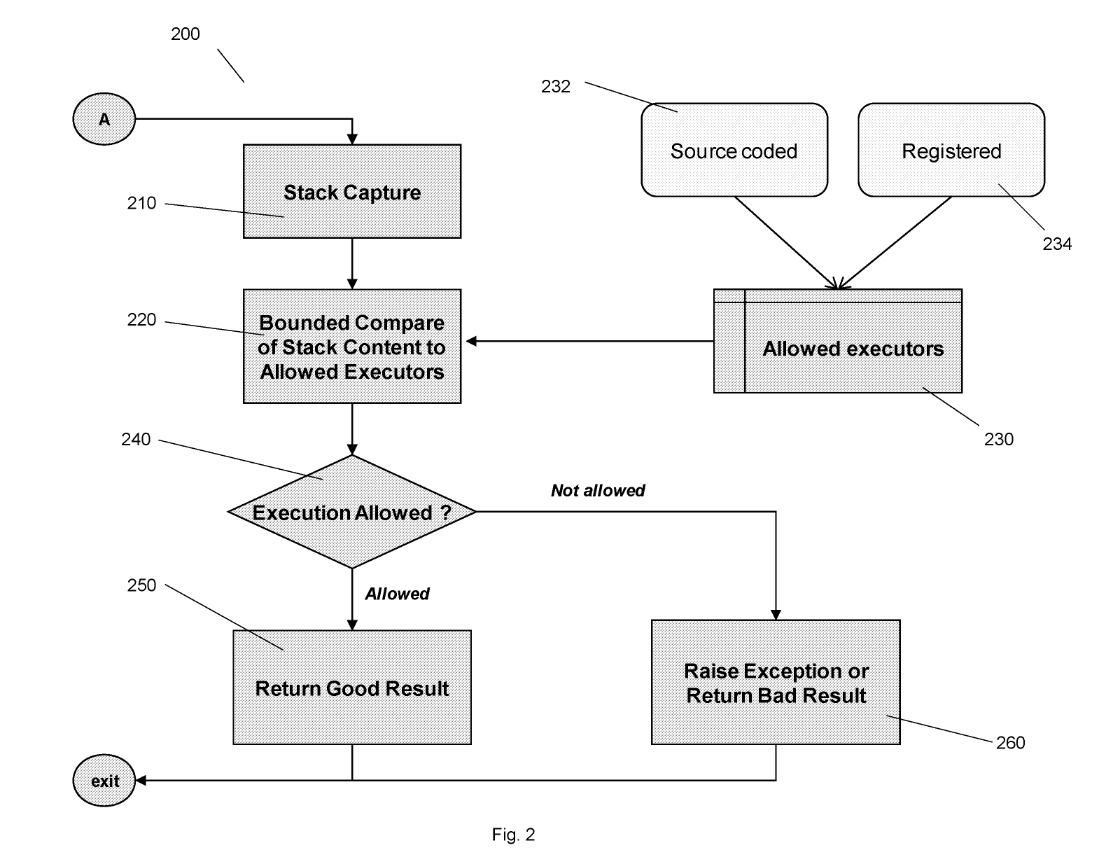

After the start of program execution the process 100 continues with execution of a first code segment at block 120. By way of example only, the first code segment of the program may be a routine, subroutine, method, function or similar type of instruction set for carrying out a particular operation. A particular operation may involve initiating components of a safety-critical program. The process will continue when the first code segment invokes a second code segment. At block 130 execution of the second code segment begins. The second code segment of the program may be a routine, subroutine, method, function or similar type of instruction set for carrying out a particular operation. A particular operation may involve destruction or release of a component of a safety-critical program. At this point a second process 200 (FIG. 2) is initiated to determine whether the second code segment has been invoked in an appropriate manner.

Referring now to FIG. 2, a block diagram of a process 200 is shown in accordance with an exemplary embodiment of the invention. The process 200 may be self-initiated by any processing segment that requires secure execution. In this example process 200 has been invoked during process 100 after execution of the second code segment begins at block 130.

The process 200 begins at block 210 where the current call stack is captured. The call stack is a data structure or list of elements, sometime called stack frames, which define a history of linked executed code segments. Each stack frame may comprise a number of data elements including a return address which points to an originating subroutine. In an object-oriented programming environment operations are available for providing ready access to the call stack. For example, in a Java implementation the runtime environment provides access to the call stack as a list of function names. In a C++ implementation direct access to the memory address of the stack or stack frames is provided. Lower-level programming languages such as C similarly provide direct access to the memory address of the stack or stack frames. By way of example only, direct access to the stack may be provided by use of embedded assembly code.

Following retrieval of the call stack the process proceeds to block 220 wherein a comparison is carried out between the retrieved stack content and a list of allowed executors, represented as block 230. In one embodiment, each allowed executor is a code segment identifier which corresponds to a code segment that is deemed to be allowed to execute or invoke the second code segment. By way of example only the code segment identifiers may be representations (e.g. textual) of code segments, memory addresses, programming-language specific data types or the like. As shown in FIG. 2, the allowed executors 230 may be derived from a source coded location 232 and/or a registered location 234. When the allowed executors are source coded 232 they are written directly into the code segment that is responsible for initiating process 200. Since the code segments cannot be modified without recompiling the entire application, both malicious and non-malicious inadvertent code segment execution is thus prevented. When the allowed executors are registered 234 they are stored in a location separate from the code segment that initiates process 200. This registered location may be a configuration file, a database, a registry, or any similar external storage location. Use of a registered location does not provide the same level of protection against malicious execution of a code segment as does source coded storage, however, greater flexibility in maintaining and updating the software is afforded.

After the allowed executors have been obtained from their appropriate source(s), the processing associated with comparison block 220 continues with a comparison between each allowed executor and the captured stack. This comparison is carried out to determine if the captured stack includes an appropriate reference to any of the allowed executors. The determination of whether the reference is appropriate may be carried out in a number of ways.

When direct access to the memory address of the stack is allowed, the stack frame that corresponds to the currently executing function can be accessed, thereby providing access to the corresponding return address of the stack frame. This return address can in turn be compared directly to the each of the allowed executors. Alternatively, process 200 may be initialized at an earlier stage of program execution to allow routines to register their corresponding addresses. A direct comparison between the stack frame addresses and the allowed executor addresses can then be carried out. The determination of whether to allow execution occurs at decision point 240 in the process 200. When a match occurs, execution is allowed and the process proceeds to block 250 where an authorization indicator (e.g. positive response) is returned to the originating first code segment. However, if no match is found the process proceeds to block 260 where a negative response is indicated by returning an unauthorized indicator such as returning of an exception condition, halting operation of the program and/or other similar mechanism.

When direct access to the stack is not available the stack will only be available as a list of representations (e.g. textual) of code segments that are currently executing. In order to make the determination of whether the reference is appropriate each allowed executor is compared to the list of code segments. This comparison may be carried out by looping over each element of the list, starting with the most recently executed function, until either the originating code segment is found or a predetermined threshold depth level has been reached. The determination of whether to allow execution occurs at decision point 240 in the process 200. If the originating class has been found prior to reaching the threshold depth level, execution will be allowed and the process will continue to block 250. If the originating class is not found, the process proceeds to block 260 where a negative response is indicated by returning an unauthorized indicator such as returning of an exception condition, halting operation of the program and/or other similar mechanism. The determination of the depth will depend on several factors such as the complexity of the software application. The depth will be chosen to achieve a predetermined likelihood of accurately determining that a code segment has been appropriately executed.

Those of ordinary skill will appreciate that the various illustrative code segments and steps described in connection with the embodiments disclosed herein may be implemented as electronic hardware, computer software, or combinations of both. The various illustrative code segments and steps have been described generally in terms of their functionality. Whether the functionality is implemented as hardware or software depends upon the particular application and design constraints imposed on the overall system. Those of ordinary skill in the art will recognize the interchangeability of hardware and software under these circumstances, and how best to implement the described functionality for each particular application. As examples, the various illustrative code segments and steps described in connection with the embodiments disclosed herein may be implemented or performed with a digital signal processor (DSP), an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, any conventional processor, controller, microcontroller, programmable logic device, array of logic elements, or state machine. The software module could reside in RAM memory, flash memory, ROM memory, EPROM memory, EEPROM memory, hard disk, a removable disk, a CD, DVD or any other form of storage medium known in the art. An exemplary processor is advantageously coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the instructions may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

Thus as described herein, when dealing with software, particularly software that is to be used in a safety application, it is often the case that invoking the execution of a segment of code needs to be or should be controlled. Unexpected calls to the code being guarded may arise on occasion. By implementing a program stack interrogator that provides a call source check with a return status indicating the validity of the calling software, unintended execution of code segments is minimized. Second generation languages such as C may implement such operations by relying on operating system interfaces and execution symbol tables. Third generation languages and higher have available operations that simplify this interrogation. For example, Java code can be manipulated to produce a stack trace that is available to the executing code and that can in turn be examined for calling class, method and even line number depending on the granularity of control needed. The following class shows one such implementation.

```
      /**
* This utility class provides a static methods for checking on the origin
* of an operation. These a safety support methods that can be used to
* ensure a call is being made from the class it is suppose to be from.
*
*
*/
public class OriginChecker {
static final int cFixedDepth = 1000;
/**
  * A method for checking that the specified class is on the call stack.
  *
  * @param pC - class of interest (origin)
  * @return true if class is present
  */
public static boolean CheckOrigin(Class pC) {
  return CheckOrigin(pC, cFixedDepth);
}
/**
  * A method for checking that the specified class is on the call stack
  * within the depth specified.
  *
  * @param pC - class of interest (origin)
  * @param pDepth - how far back to expect the call was made
  * @return true if class is present within the depth specified
  */
public static boolean CheckOrigin(Class pC, int pDepth) {
  boolean rcbool = false;
  if (!(null == pC)) {
  final int depth = pDepth;
  StackTraceElement[ ] Stack = null;
  try {
    throw new Throwable( );
  }
  catch (Throwable T) {
    Stack = T.getStackTrace( );
  }
    // search the stack trace for the class of interest
    String classname = null;
    int count = 0;
    for (StackTraceElement se : Stack) {
    classname = se.getClassName( );
    if (classname.equals(pC.getName( ))) {
      rcbool = true;
      break;
    }
    count++;
    }
    if (count > depth) {
    rcbool = false;
    }
  }
  return rcbool;
}
/**
  * A method for checking that the specified class.method is on the call
  * stack within the depth specified.
  *
  * @param pC - class of interest (origin)
  * @param pMethod - the method within the class
  * @return true if class is present within the depth specified
  */
public static boolean CheckOrigin(Class pC, String pMethod) {
  return CheckOrgin(pC, pMethod, cFixedDepth);
}
/**
  * A method for checking that the specified class.method is on the call
  * stack within the depth specified.
  *
  * @param pC - class of interest (origin)
  * @param pMethod - the method within the class
  * @param pDepth - how far back to expect the call was made
  * @return true if class is present within the depth specified
  */
public static boolean CheckOrigin(Class pC, String pMethod,
int pDepth) {
  boolean rcbool = false;
  if (!((null == pC) || (null == pMethod))) {
  final int depth = pDepth;
  StackTraceElement[ ] Stack = null;
  try {
    throw new Throwable( );
    }
    catch (Throwable T) {
    Stack = T.getStackTrace( );
    }
    // search the stack trace for the class of interest
    String classname = null;
    String method = null;
    int count = 0;
    for (StackTraceElement se : Stack) {
    classname = se.getClassName( );
    method = se.getMethodName( );
    if (classname.equals(pC.getName( )) && pMethod.equals(method)) {
      rcbool = true;
      break;
    }
    count++;
    }
    if (count > depth) {
    rcbool = false;
    }
  }
    return rcbool;
  }
}
```

By way of example only, the present invention may be implemented in code intended for “safe” applications, code that implements access controls, and code that controls potentially hazardous processes. For example, rail code contains data elements describing the rail network, such as tracks, switches, blocks, and the like. These elements are program load configurable but need to reside in memory (e.g. for performance reasons). Once generated, the data set is closed. No new elements should be created. Therefore, data element creation occurs only during the initialization sequence. Generation of a new element is restricted to initialization routines and checked for in the data element construction code.

While the foregoing invention has been described with reference to the above-described embodiments, various modifications and changes can be made without departing from the spirit of the invention. Accordingly, all such modifications and changes are considered to be within the scope of the appended claims.

What is claimed is:

1. A method of preventing inadvertent execution of one or more code segments of a computer program in a processor comprising:
providing a memory having a first code segment and a second code segment, said first code segment having a first code segment identifier;
associating one or more allowed code segment identifiers with said second code segment;
executing on said processor said first code segment, said first code segment including an instruction for invoking execution of said second code segment;
executing on said processor said second code segment wherein said second code segment determines whether said first code segment identifier is the same as one of said one or more allowed code segment identifiers; and
returning an indicator that enables execution of said second code segment to continue when said first code segment identifier is determined to be the same as one of said one or more allowed code segment identifiers.

2. The method of claim 1, wherein said associating further comprises performing said association within said second code segment.

3. The method of claim 1, wherein said associating further comprises retrieving said allowed program identifiers from a source external to said second program.

4. The method of claim 3, wherein said source is a registry.

5. The method of claim 3, wherein said source is a configuration file.

6. The method of claim 1, further comprising preventing execution of said second code segment from continuing when said first code segment identifier is determined to be different from one of said one or more allowed code segment identifiers.

7. A computer readable medium containing computer executable instructions to perform a method of preventing inadvertent execution of one or more segments of computer program in a processor said method comprising:
providing a memory having a first code segment and a second code segment, said first code segment having a first code segment identifier;
associating one or more allowed code segment identifiers with said second code segment;
executing on said processor said first code segment, said first code segment including an instruction for invoking execution of said second code segment;
executing on said processor said second code segment wherein said second code segment determines whether said first code segment identifier is the same as one of said one or more allowed code segment identifiers; and
returning an indicator that enables execution of said second code segment to continue when said first code segment identifier is determined to be the same as one of said one or more allowed code segment identifiers.

8. The computer readable medium of claim 7, wherein said associating further comprises making said association within said second code segment.

9. The computer readable medium of claim 7, wherein said associating further comprises retrieving said allowed program identifiers from a source external to said second program.

10. The computer readable medium of claim 9, wherein said source is a registry.

11. The computer readable medium of claim 9, wherein said source is a configuration file.

12. The computer readable medium of claim 7, further comprising preventing execution of said second code segment from continuing when said first code segment identifier is determined to be different from one of said one or more allowed code segment identifiers.

13. A method of preventing inadvertent execution of one or more segments of a safety-critical program in a processor comprising:
associating one or more allowed code segment identifiers with a first code segment;
executing on said processor the first code segment;
receiving a list of currently executing code segments;
comparing one or more of said currently executing code segments to said one or more allowed code segment identifiers; and
returning an indicator that enables execution of said first code segment to continue when one of said one or more allowed code segment identifiers matches one of said one or more currently executing code segments.

14. The method of claim 13, wherein said associating further comprises making said association within said first code segment.

15. The method of claim 13, wherein said associating further comprises retrieving said allowed program identifiers from a source external to said first code segment.

16. The method of claim 15, wherein said associating further comprises retrieving said allowed program identifiers from a registry.

17. The method of claim 15, wherein said associating further comprises retrieving said allowed program identifiers from a configuration file.

18. The method of claim 13, further comprising preventing execution of said first code segment from continuing when none of said one or more allowed code segment identifiers matches any of said one or more currently executing code segments.

19. The method of claim 13, said comparing further comprising comparing a subset of said currently executing code segments to said one or more allowed code segment identifiers.

20. The method of claim 19, wherein said subset is determined based on a predetermined number of previously executed code segments.
